(19) United States
(12) Patent Application Publication
(10) Pub. No.: US 2008/0120807 A1
(43) Pub. Date: May 29, 2008

(54) Hinge Device and Method for Operating the Same

(75) Inventor: Bernd Heger, Haunshein (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munich (DE)

(21) Appl. No.: 11/794,213

(22) PCT Filed: Dec. 2, 2005
(86) PCT No.: PCT/EP05/56436

§ 371 Date: Jun. 21, 2007

(30) Foreign Application Priority Data
Dec. 23, 2004 (DE) 10 2004 062 308.2

(51) Int. Cl. E05D 11/06; E05D 11/10

(52) U.S. Cl. 16/319; 16/386

(57) ABSTRACT

A hinge device and to several methods for operating the same. The hinge device comprises at least one first and one second hinge element and a hinge on which the two hinge elements are mounted so as to be rotated in relation to each other. The aim of the invention is to provide a hinge device which allows to reduce the risk of injury incurred when the user (unintentionally) catches his finger in the hinge elements during a movement of the same. For this purpose, the two hinge elements are provided with bores. aligned with each other and a pin element can be detachably inserted in at least one of the bores.

The invention relates to a hinge device having at least one first and one second hinge element as well as a pivot joint around which the two hinge elements are mounted rotatably relative to each other. The invention relates further to three alternative methods for operating said hinge device.

Hinge devices of said type are basically known from the prior art and are employed predominantly in cabinets or built-in domestic appliances. There they serve typically to hinge a door to the body of the cabinet or built-in appliance. To realize required special opening and closing movements of the door, said hinge devices can be embodied also as multilink hinges. Especially when having a spring system that supports closing, the hinge devices pose the not inconsiderable hazard of possibly causing injuries due to trapping, cutting, or crushing during installation and repair work as well as during day-to-day use of the cabinets or built-in appliances; that applies particularly to fingers should these be (accidentally) caught between the hinge device's hinge elements while the device is snapping shut in an uncontrolled manner. In the USA in particular, the described potential hazard is associated with a risk of not insubstantial claims for damage by injured persons against the manufacturers of cabinets or built-in appliances having said hinge devices. The manufacturers are hence for the reasons cited at pains to minimize the described risk of injury.

Various possibilities for reducing the described risks of injury are known from the prior art. A first possibility for reducing the risk of injury is to embody the hinge devices such that they have a restricted opening angle, as has been realized in, for example, a commercially available multilink hinge. Another possibility for minimizing the risk of injury is to provide a suitable elastic covering for the hinge, as has been described in, for instance, the German publication of the unexamined application DE 44 18 238 A1. The covering described therein will in any position of an open door prevent fingers, for example, from being accidentally caught between the hinge device's hinge elements when a door hinged by means of the hinge device is swung.

Proceeding from said prior art, the object of the invention is to provide alternative embodiments of a known hinge device having at least two hinge elements and of methods for operating it, which embodiments will reduce or totally preclude a risk of injury and crushing should fingers, for example, be (accidentally) caught between the hinge elements while these are moving.

Said object is achieved by means of the subject matter of the claims. That is characterized in that the first hinge element has a first bore and the second hinge element has a second bore, in that the two bores will mutually align at a predefined turning angle of the second hinge element relative to the first hinge element, and in that a pin element is provided for detachable insertion into the first and/or second bore.

Depending on the hinge device's specific position in which the user thereof inserts the pin element into the first and/or second bore, the user can optionally realize a restricted opening angle, a restricted closing angle, or arresting of the hinge in a predefined opened position; thanks to the embodiment claimed for the hinge device, all three cited restricting possibilities can advantageously be optionally set on one and the same hinge device. In each case one of the described restricting possibilities can be expedient depending on the specific situation in which the cabinet or built-in appliance having the hinge is being operated, whether, for example, for installation or repair purposes. Unlike the restricted opening angle, the restricted closing angle and possibility of arresting the hinge device offer a safeguard against accidental closing of the hinge device due to, for instance, a spring action. Thanks to the embodiment claimed of the hinge device's physical design and to the restriction achieved thereby on the freedom of the hinge device's hinge elements to move, the risk of injury to users of the hinge device will be significantly reduced when a restricted opening or closing angle has been set, and even totally precluded when the hinge elements have been arrested. Primarily through restricting the opening angle it is insured that the gap on the hinge side between a front furniture plate mounted on, say, a refrigerator door and a kitchen-appliance front adjacent thereto cannot be reduced to such an extent that crush injuries can be caused to a child's hand should it accidentally be caught in the gap. In the case of hinges, in particular multilink hinges, in which the moving part is forced relative to the stationary part into its open or closed position by, for example, a spring, it is also advantageous, besides restricting the opening angle, also to prevent accidental closing, due to the spring action (snapping-closed effect), of a door, in particular a refrigerator door, hinged by means of the hinge in order thereby to obviate crush injuries to a child's hand due to its being accidentally caught between the shearing hinge components.

For arresting the pin element in at least one of the bores it is advantageous for the bore and the pin element to have complementary threads so that the pin element can be screwed into the bore.

It is likewise advantageous for the bores in the two hinge elements and for the pin element to have the same cross-section, with basically any cross-section being possible. Both the provision of the thread and the presence of suitably dimensioned equal cross-sections will prevent any play between the hinge elements, or the pin element's becoming detached therefrom, and in that way contribute significantly to the hinge device's safety and hence to reducing its potential to cause injuries.

Further advantageous embodiments of the hinge device are the subject of the dependent claims.

The aforementioned object of the invention is furthermore achieved by means of three alternative methods for operating the hinge device. As already indicated above with reference to the claimed embodiment of the hinge device, said three methods serve to realize a restricted opening angle, to arrest the hinge device in a predefined opened position, and to realize a restricted closing angle. The advantages of said methods correspond to those cited above with reference to the claimed hinge device.

Accompanying the description are a total of 10 figures, in which

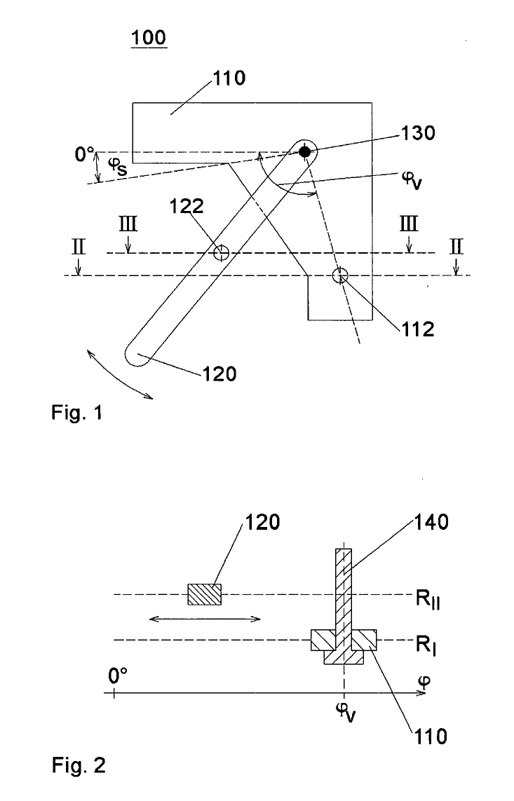

FIG. 1 is a plan view of the inventive hinge device in a first turning-angle position;

FIG. 2 is a cross-sectional view of the hinge device in the first turning-angle position according to FIG. 1 with a first alternative for inserting the pin element;

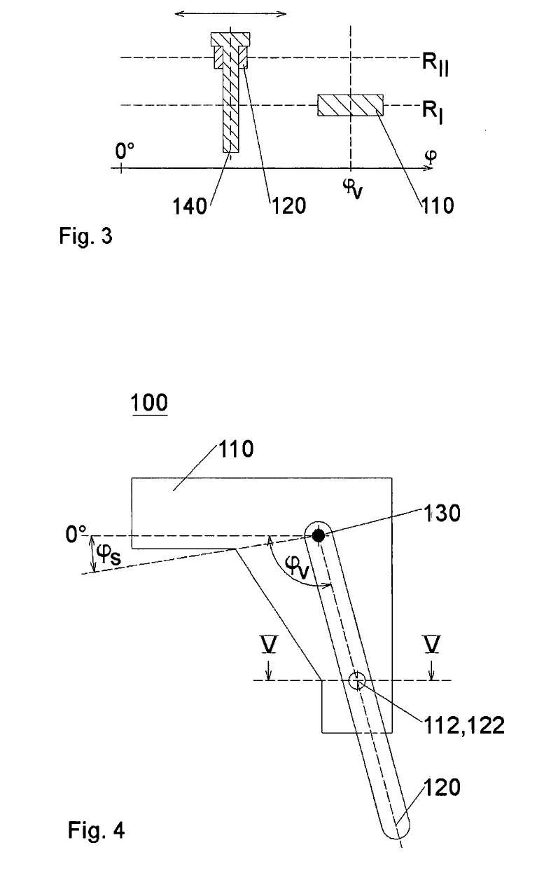

FIG. 3 is a cross-sectional view of the hinge element in the first turning-angle position according to FIG. 1 with a second alternative for inserting the pin element;

FIG. 4 is a plan view of the inventive hinge device in a second turning-angle position, an arresting position;

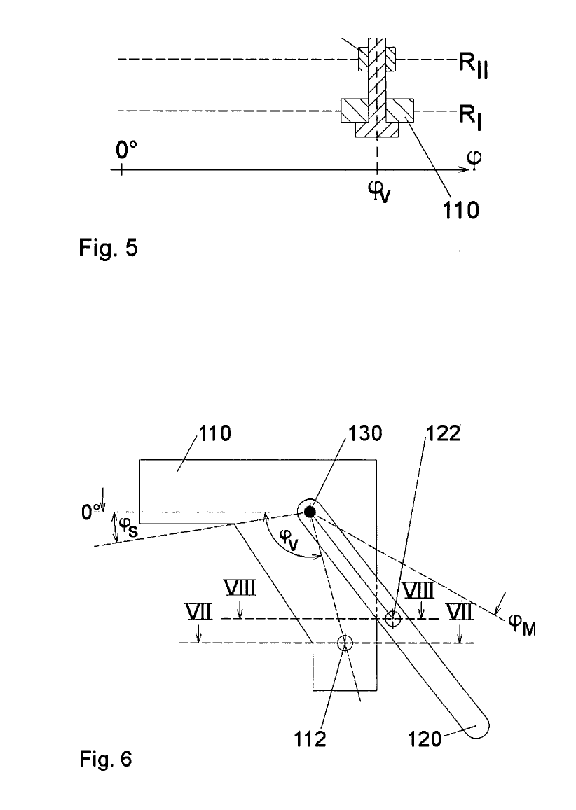

FIG. 5 is a cross-sectional view of the hinge device in the arresting position according to FIG. 4;

FIG. 6 is a plan view of the inventive hinge device in a third turning-angle position;

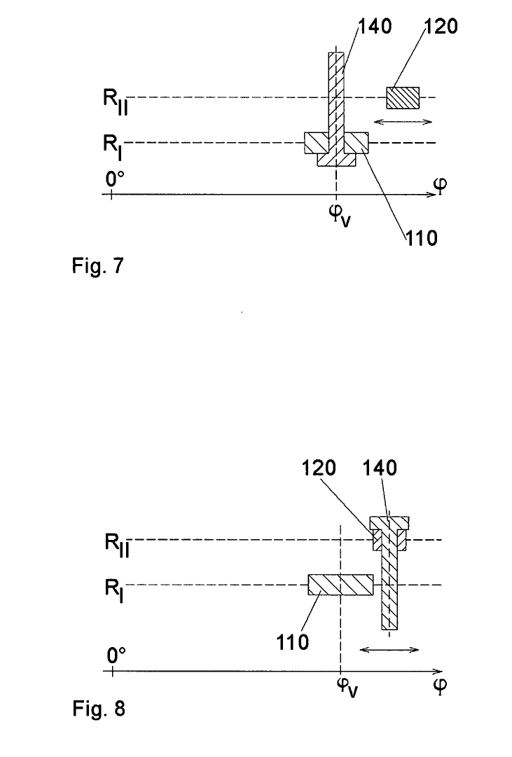

FIG. 7 is a cross-sectional view of the hinge device in the third turning-angle position according to FIG. 6 with a first alternative for inserting the pin element;

FIG. 8 is a cross-sectional view of the hinge device according to FIG. 6 with a second alternative for inserting the pin element;

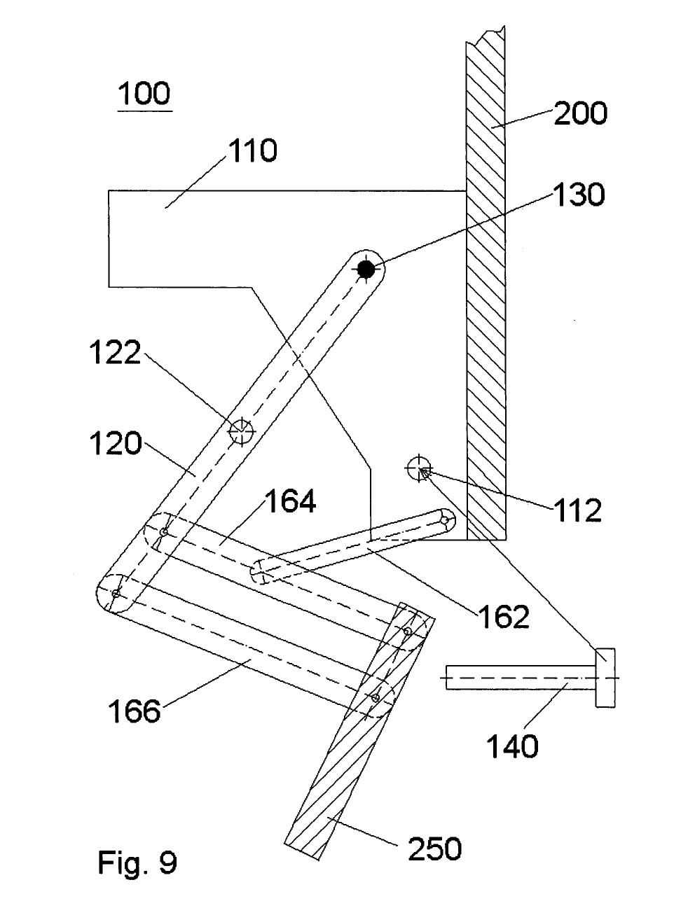

FIG. 9 is a plan view of the inventive hinge device embodied as a multilink hinge in the first turning-angle position; and

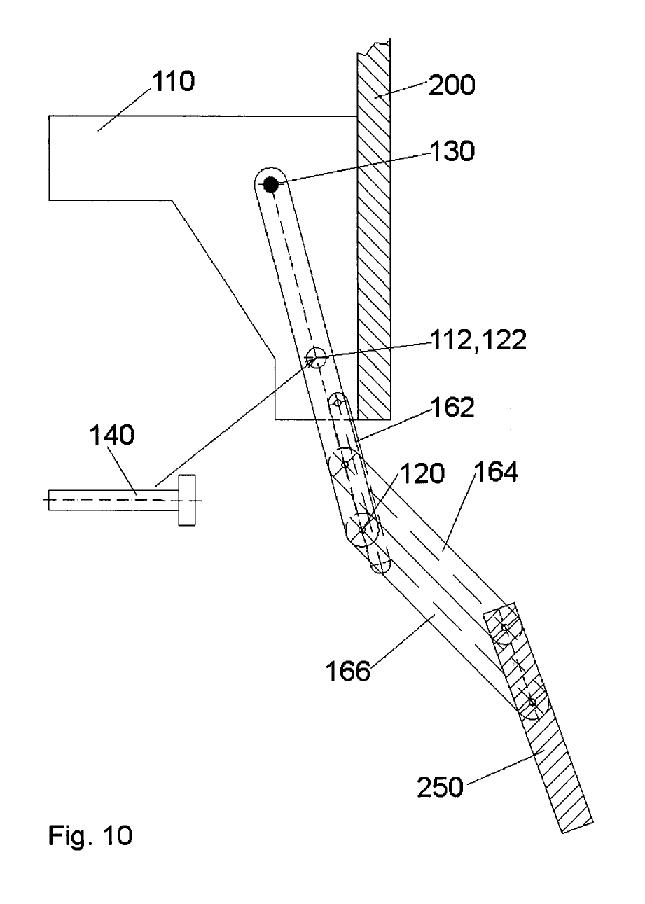

FIG. 10 is a plan view of the hinge device embodied as a multilink hinge in the second turning-angle position.

The invention is described in detail below in the form of exemplary embodiments with reference to the cited figures. The same reference numerals are used in all the figures to identify identical elements.

All relationships (less than, greater than) between angles indicated in the description and claims relate to the coordination system shown in the figures. The angular relationships must be interpreted accordingly differently for other coordination systems. A turning angle or, as the case may be, opening angle is designated generally as (P.

FIG. 1 is a plan view of the inventive hinge device 100. It comprises a first hinge element 110 that can be, for example, secured stationarily to the housing of a cabinet or built-in domestic appliance. The hinge device 100 further comprises a second hinge element 120 that is mounted rotatably relative to the first hinge element 110 via a pivot joint 130. For example a door (not shown in FIG. 1) can be mounted directly or indirectly, which is to say possibly via further hinge elements, on the second hinge element 120 for covering an opening in the cabinet or built-in appliance.

According to the invention, the first hinge element 110 has a first bore 112 and the second hinge element 120 a second bore 122. Said two bores are equidistant from the pivotal point, defined by the pivot joint 130, around which the two hinge elements 110, 120 can rotate relative to each other. That means that if the second hinge element 120 is turned through a predefined turning angle φ_{V} relative to the first hinge element and the two hinge elements overlap, then the two bores 112, 122 will mutually align. The two bores 112, 122 preferably have the same cross-section, and in the case of a circular embodiment the same diameter, which is preferably dimensioned such that it will be able to accommodate, free from play, a pin element 140 having the same cross-section. The pin element 140 can be inserted optionally into either the first and/or the second bore; that is described in detail further below with reference to the following figures.

FIG. 1 is a plan view of the inventive hinge device 100 wherein the second hinge element 120 has been turned into a turning-angle position within a first turning-angle sector delimited on the one hand by a minimum closing angle φ_{S} and on the other, toward larger opening angles, by an opening angle that is less than the predefined turning angle φ_{V}. The minimum closing angle φ_{S} will typically have been reached when the hinge device has been installed in a cabinet or built-in appliances and a door, connected to, for example, the second hinge element 120, of the cabinet or built-in appliance has been closed.

FIG. 2 is a cross-sectional view of the hinge device 100 according to FIG. 1 across the sectional plane II indicated therein. It can be seen that the two hinge elements 110, 120 move relative to each other in separate rotational planes R_{I} and R_{II}. Specifically illustrated there is a movement of the second hinge element 120 within the first turning-angle sector, which is why the second hinge element 120 here always moves to the left of the first hinge element 110. The possible movement of the two hinge elements relative to each other is indicated by the double arrow that has been drawn. Shown in FIG. 2 is a first alternative for handling the pin element 140. Said first alternative consists specifically in inserting the pin element 140 into the first bore 112 of the first hinge element 110 such that it will project into the rotational plane R_{II} of the second hinge element 120; the pin element 140 must therefore be embodied as of suitable length. A pin element can be dispensed with in the second bore 122 of the second hinge element 120. If the second hinge element, as shown in FIG. 2, was put into a turning-angle position within the first turning-angle sector according to FIG. 1 prior to insertion of the pin element 140, then the pin element 140 projecting into the rotational plane R_{II} will act as a stop and restrict the freedom of movement of the second hinge element 120 to the first turning-angle sector. Expressed another way: The pin element 140 will in this constellation effect a restricted opening angle because a further opening of the hinge device 100, meaning a turning of the second hinge element 120 past the pin element 140 onto the right-hand side of the pin element, will be prevented by the pin element. Owing to the real extents both of the pin element 140 and of the second hinge element 120, the first turning-angle sector is delimited toward large opening angles not by the angle φ_{V} but, as mentioned above, by a somewhat smaller turning angle.

FIG. 3 shows a possibility that is an alternative to that shown in FIG. 2 for realizing a restricted opening angle. In FIG. 3 it is presupposed also that the second hinge element 120 is turned relative to the first hinge element 110 into the first turning-angle sector, as shown in FIG. 1, before the pin element is inserted. In contrast to FIG. 2, however, the restricted opening angle according to FIG. 3 is realized by inserting the pin element 140 not into the first hinge element 110 but into the second bore 122 of the second hinge element 120. It must, however, be noted therein that the pin element 140 is embodied and inserted into the second hinge element 120 in such a way that it will project into the rotational plane R_{I} of the first hinge element 110. A turning of the second hinge element 120 toward larger opening angles, meaning in the direction of the arrow to the right according to FIG. 3, will in the case of the arrangement shown in FIG. 3 be restricted through stopping of the pin element 140 against the first hinge element 110 at a specific turning angle. Here, too, the first turning-angle sector will be restricted toward large opening angles not precisely but, owing to the widths of the materials, only approximately by the predefined turning angle φᵥ.

FIG. 4 is a plan view of the inventive hinge device 100, with the second hinge element 120 being turned into a second turning-angle position, represented by the predefined turning angle φ_{V}, relative to the first hinge element. The turning position is therein that at which the two bores 112 and 122 of the two hinge elements 110, 120 are mutually aligned.

FIG. 5 is a cross-sectional view of the hinge device 100 in the second turning-angle position shown in FIG. 4. The inventively coinciding bores 112, 122 in said turning-angle position will enable the pin element 140 embodied as suitably long to be inserted into both bores such that both will be penetrated simultaneously by the pin element 140, as is shown in FIG. 5. By means of said type of arrangement the two hinge elements 110 and 120 will be securely mutually arrested; that means that the two hinge elements will no longer be able to move relative to each other. Releasable arresting of said kind can be desired and advantageous in certain operating situations of the hinge, for example when installation and repair work is being carried out on the cabinet or built-in appliance in which the hinge device is used. Preventing the hinge elements from moving relative to each other will preclude any trapping or crushing particularly of fingers owing to an uncontrolled closing or opening of the hinge.

FIG. 6 is a plan view of the inventive hinge device 100, with the second hinge element 120 being in a third turning-angle position in relation to the first hinge element 110 in a second turning-angle sector. The second turning-angle sector is delimited toward small opening angles by a lower opening angle and toward large opening angles by a maximum opening angle φ_{M}. Owing to the cited material extents of the pin element 140 and hinge element, the lower opening angle is slightly larger than the predefined opening angle φ_{V}.

FIG. 7 is a cross-sectional view of the hinge device 100 in the third turning-angle position according to FIG. 6. According to the first alternative, shown in FIG. 7, for realizing a restricted closing angle, the pin element 140 has been inserted into the first hinge element 110 in such a way that it projects into the rotational plane R_{II} of the second hinge element. A turning of the second hinge element 120 toward smaller opening angles, meaning in the closing direction, is restricted thereby. Restricting will have been achieved when the second hinge element 120 has stopped against the pin element 140 in the case of a movement to the left in FIG. 7.

FIG. 8 is a second alternative for realizing a restricted closing angle for the hinge device 100 according to FIG. 6. In contrast to the first alternative according to FIG. 7, in the case of the second alternative shown in FIG. 8 the pin element 140 has been inserted not into the bore 112 of the first hinge element 110 but into the bore 122 of the second pin element 120 in such a way that it projects into the rotational plane R_{I}. The restricted closing angle is in that case realized through stopping of the pin element 140 against the first hinge element 110 when the second hinge element 120 has been turned toward smaller opening angles φ, meaning to the left in FIG. 8.

FIG. 9 shows the hinge device 100 in an embodiment as a multilink hinge. Apart from the first and second hinge element 110, 120, the hinge device 100 in that embodiment also includes further hinge elements 162, 164, 166 for hinging a door 250 to a body of an item of furniture, for example a cabinet or built-in kitchen appliance. A wall of the body of an item of furniture has been assigned the reference numeral 200 in FIG. 9; the first hinge element 110 has, by way of example, been screwed to said wall. The hinge device 100 is in FIG. 9 shown in the first turning-angle or opening-angle position, with the second hinge element 120 having been swung into a position within the first turning-angle sector. For realizing a restricted opening angle it is recommended here, too, for the pin element 140 to be inserted into, for example, the first bore 112 of the first hinge element 110. The multilink embodiment of the hinge device 100 serves to realize required special opening and closing movements of the door 250 relative to the furniture body 200; said special movements may be necessary in certain installation situations of the cabinet or built-in domestic appliance.

Finally, FIG. 10 shows the multilink embodiment, known already from FIG. 9, of the hinge device 100, although here in the second turning-angle position. The door 250 is here open wider than shown in FIG. 9 and assumes a position relative to the first hinge element 110 and body wall 200 that is predefined by the multilink embodiment. In the second turning-angle position shown it is possible, as described above with reference to FIGS. 4 and 5, to achieve arresting of the hinge device together with all hinge elements through inserting the pin element 140 into the bores 112 and 122 in such a way that it will penetrate both bores simultaneously.

The following applies to all exemplary embodiments described hitherto with reference to FIGS. 1 to 10:

The cross-sections of the bores 112, 122 and pin element 140 need by no means be circular; rather it is the case that basically any cross-sectional shapes are possible. The size of the bores is, though, preferably uniformly selected such that they will be able to accommodate the pin element 140 free from play.

To prevent the pin element 140 from dropping out of the bores 112, 122 or, as the case may be, to realize secure arresting of the pin element 140 in the bores even when the hinge device is subjected to dynamic loading, it is advantageous for complementary threads to be provided in the bores and on the pin element so that the pin element can be screwed into the bores.

It was mentioned above with reference to FIGS. 2, 3, 7, and 8 that the first and second turning-angle sector are each delimited by stopping of the hinge element against the pin element 140. Specifically, that means that the two angle sectors are defined in terms of their size and position not only by the cited material extents of the hinge elements and pin element but substantially also by the contours K—see FIG. 1—of the hinge elements and by the distance between the bores 112, 122 and the pivotal point defined by the pivot joint 130.

1-8. (canceled)

9. A hinge device comprising:
a first hinge element and a second hinge element as well as a pivot joint around which the two hinge elements are mounted rotatably relative to each other;
the first hinge element having a first bore and the second hinge element having a second bore;
the two bores being mutually aligned at a predefined turning angle of the second hinge element relative to the first hinge element; and
a pin element being detachable inserted into at least one of the first and second bores.

10. The hinge device as claimed in claim 9, wherein at least one of the two bores and the pin element have complementary threads so that the pin element can be screwed into at least one of the bores.

11. The hinge device as claimed in claim 9, wherein the two bores and the pin element have the same cross-section.

12. The hinge device as claimed in claim 9, wherein the first hinge element is secured stationarily to a housing of a built-in domestic appliance, and the second hinge element is secured to a door for closing an opening in the housing.

13. The hinge device as claimed in claim 12, wherein the hinge device is embodied as a multilink hinge which apart from the first and second hinge element also has at least one further hinge element for indirectly connecting the second hinge element to the door and for realizing a predefined opening and closing movement of the door relative to the housing.

14. A method for operating a hinge device having at least one first hinge element with a first bore and a second hinge element with a second bore, with the two bores being arranged in such a way that they will mutually align at a predefined turning angle of the second hinge element relative to the first hinge element; and with the two hinge elements being mounted rotatably relative to each other in separate rotational planes, the method comprising the following acts:
turning the second hinge element relative to the first hinge element into a turning-angle position within a turning-angle sector delimited on the one hand by a minimum closing angle and on the other by an opening angle that is less than the predefined turning angle; and
at least one of:
detachably inserting a pin element into the first bore but not into the second bore in such a way that the pin element will project into the rotational plane of the second hinge element; and
detachably inserting a pin element into the second bore but not into the first bore in such a way that the pin element will project into the rotational plane of the first hinge element.

15. A method for operating a hinge device comprising a first hinge element with a first bore and a second hinge element with a second bore, with the two hinge elements being mounted rotatably relative to each other; and with the two bores mutually aligning at a predefined turning angle of the second hinge element relative to the first hinge element, the method comprising the following acts:
turning the second hinge element relative to the first hinge element through the predefined turning angle; and
detachably inserting a pin element into the first and second bore in such a way that the pin element will penetrate both bores simultaneously.

16. A method for operating a hinge device having at least one first hinge element with a first bore and one second hinge element with a second bore, with the two bores being arranged in such a way that they will mutually align at a predefined turning angle of the second hinge element relative to the first hinge element; and with the two hinge elements being mounted rotatably relative to each other in separate rotational planes, the method comprising the following acts:
turning the second hinge element relative to the first hinge element into a turning-angle position within a turning-angle sector delimited on the one hand by an opening angle that is larger than the predefined opening angle and, on the other, by a maximum opening angle; and
at least one of:
detachably inserting a pin element into the first but not into the second bore in such a way that the pin element will project into the rotational plane of the second hinge element; and
detachably inserting a pin element into the second bore but not into the first bore in such a way that the pin element will project into the rotational plane of the first hinge element.
